(19) United States
(12) Patent Application Publication
(10) Pub. No.: US 2026/0063246 A1
(43) Pub. Date: Mar. 5, 2026

(54) DEVICE AND METHOD FOR TRANSFERRING CRYOGENIC FLUID

(71) Applicant: L'Air Liquide, Societe Anonyme pour l'Etude et l’Exploitation des Procedes Georges Claude, Paris (FR)

(72) Inventors: Laurent ALLIDIERES, Paris (FR); Joshua LIGHT, Houston, TX (US); Wassim OUAKRIM, Sassenage (FR)

(21) Appl. No.: 19/311,035

(22) Filed: Aug. 27, 2025

(30) Foreign Application Priority Data
Aug. 30, 2024 (FR) FR2409269

(51) Int. Cl. F17C 5/02; F17C 5/00; F17C 13/04

(52) U.S. Cl. CPC F17C 5/02; F17C 5/002; F17C 13/04; F17C 2205/0326; F17C 2205/0355; F17C 2221/012; F17C 2225/0161; F17C 2227/0135; F17C 2265/061

(57) ABSTRACT

The invention relates to a cryogenic fluid transfer device comprising a first tank storing a cryogenic fluid, a second cryogenic receiving tank, a fluid transfer circuit connecting the tanks and comprising a first pipe that connects the upper parts of the first and second tanks and has a first valve, a second pipe that connects the lower part of the first tank to the second cryogenic tank and has a pump, the pump and the first valve being configured to place the upper parts of the first and second tanks in fluidic communication, the first pipe comprising a bypass portion equipped with a heater and a set of one or more valves configured to make it possible to modify the temperature of the flow of gas transferred from the second cryogenic tank to the first tank via the first pipe.

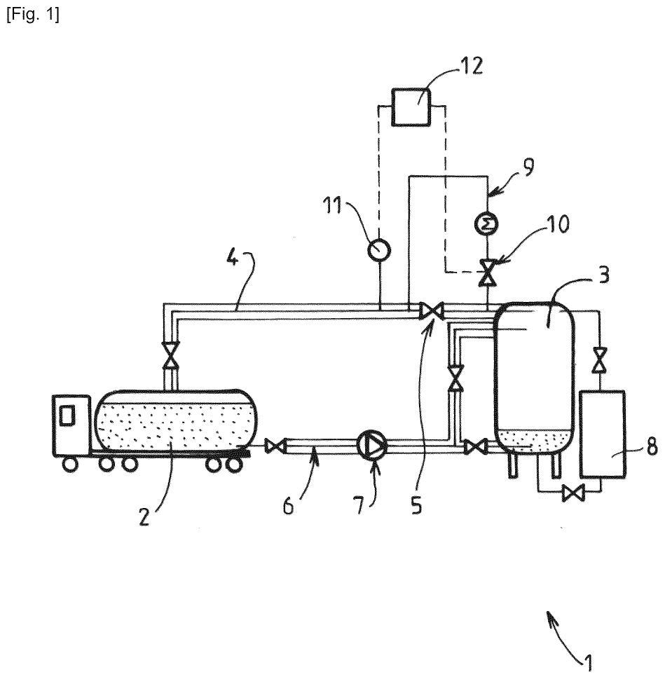

### CROSS REFERENCE TO RELATED APPLICATIONS

This application claims the benefit of priority under 35 U.S.C. § 119 (a) and (b) to French patent application No. FR2409269, filed Aug. 30, 2024, which is herein incorporated by reference in its entirety.

### FIELD OF THE INVENTION

The invention relates to a device and to a method for transferring cryogenic fluid.

The invention relates more particularly to a device for transferring cryogenic fluid comprising a first tank for distributing cryogenic fluid, said first tank storing a cryogenic fluid with a lower liquid phase and an upper gas phase, a receiving second cryogenic tank housing a cryogenic fluid comprising a lower liquid phase and an upper gas phase, a fluid transfer circuit connecting the first and the second tank, the transfer circuit comprising a first pipe that connects the upper parts of the first and second tanks and comprises at least one first valve, the transfer circuit comprising a second pipe that connects the lower part of the first tank to the second tank, the second transfer pipe comprising a pump comprising an inlet connected to the first tank and an outlet connected to the second tank, the pump and the first valve being configured to place the upper parts of the first and second tanks in fluidic communication by opening the first valve, for example before or during a transfer of liquid from the first tank to the second tank by way of the pump.

The invention applies in particular to the delivery of liquefied hydrogen.

### BACKGROUND OF THE INVENTION

Such a device is described in document EP4153900A1. Other devices are described in EP3690303A1 or FR3041624A1.

In order to refuel a receiving cryogenic tank, the cryogenic liquid has to be transferred from a semi-trailer to the receiving tank by way of a pressure difference. Generally, the receiving tank is at a higher pressure than the pressure in the tank of the delivery trailer.

In a known solution, an atmospheric heater is generally placed beneath the delivery semi-trailer so as to allow the pressurization and the transfer of its contents to a customer tank.

However, this space heating has drawbacks. Thus, it is difficult to control the performance since this is related to the weather conditions (temperature, wind, humidity).

This generates stratification in the gas headspace of the delivery tank (increase in gas temperature). This tends to heat the liquid hydrogen delivered to the customer (especially in the case of multiple deliveries). Thus, the hydrogen delivered is of lower quality.

This solution also requires the delivery tank to be pressurized before starting the transfer. This can last from 15 min to 60 min depending on the level in the tank.

In addition, the atmospheric heater consumes a useful cryogenic liquid and the regulation requires the driver to perform manual operations, in particular managing the priming.

This can also create a cryogenic cloud and condensation of liquid oxygen beneath the delivery tank. Finally, this solution does not make it possible to recycle the boil-off gases generated in the receiving tank.

### SUMMARY OF THE INVENTION

One aim of the present invention is to overcome all or some of the above-mentioned drawbacks of the prior art.

In an effort to overcome the deficiencies of the prior art discussed, supra, the device according to the invention, which is otherwise in accordance with the generic definition thereof given in the preamble above, is configured such that the first pipe comprises a bypass portion equipped with a heater and a set of one or more valves configured to make it possible to modify the temperature of the flow of gas transferred from the second tank to the first tank via the first pipe.

Moreover, embodiments of the invention may have one or more of the following features:
the bypass portion comprises two ends respectively connected on either side of the first valve,
the bypass portion comprises a second flowrate control valve,
the device comprises a temperature sensor measuring the temperature in the first pipe between the bypass portion and the first tank,
the device comprises an electronic control unit for acquiring and processing data, the control unit being configured to receive a measurement signal from the temperature sensor and to control the second flowrate control valve on the basis of this measurement,
the second pipe comprises an end connecting the lower part of the first tank to the lower part of the second tank,
the second pipe comprises an end connecting the lower part of the first tank to the upper part of the second tank,
at least part of the first pipe is thermally insulated, for example via vacuum insulation.

The invention also relates to a method for transferring cryogenic fluid between a first tank for distributing cryogenic fluid and a second cryogenic tank of a device in accordance with any one of the features above or below, the method comprising a step of transferring liquid from the first tank to the second tank via the pump and, prior to and/or simultaneously with this liquid transfer step, placing the upper parts of the first and second tanks in fluidic communication by opening the first valve.

According to other possible particular features:
the method has a step of circulating, in the first pipe, a flow of gas taken from the second tank,
at least part of the flow of gas circulated in the first pipe is preheated in the bypass portion,
the flow of gas circulated in the first pipe is transferred to the first tank at a determined temperature controlled by regulating the proportion of the flow of gas allowed to pass through the bypass portion,
during the step of transferring liquid from the first tank to the second tank by way of the pump, the liquid is transferred into the lower liquid part and/or into the upper gas part of the second tank.

The invention may also relate to any alternative device or method comprising any combination of the features above or below within the scope of the claims.

Other particular features and advantages will become apparent upon reading the following description, which is provided with reference to the figures.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

The invention will be understood better on reading the following description and on studying the accompanying figures. These figures are given merely by way of illustration and do not in any way limit the invention.

The Figure is a schematic partial view of an example of the structure and operation of a transfer device according to the invention.

### DETAILED DESCRIPTION OF THE INVENTION

Throughout the figures, the same reference signs relate to the same elements.

In this detailed description, the following embodiments are examples. Although the description refers to one or more embodiments, this does not mean that the features apply only to a single embodiment. Individual features of different embodiments may also be combined and/or interchanged to provide other embodiments.

As illustrated, the device 1 for transferring cryogenic fluid comprises a first tank 2 for distributing cryogenic fluid, for example a mobile tank 2 mounted on a semi-trailer. Conventionally, the first tank 2 stores a cryogenic fluid, for example hydrogen, with a liquid phase in the lower part and a gas phase in the upper part.

The device 1 comprises a second, for example fixed, cryogenic tank 3 for receiving the same fluid, housing or intended to house a cryogenic fluid with a liquid phase in the lower part and a gas phase in the upper part. The device 1 comprises a fluid transfer circuit that is able to connect the first 2 and the second 3 tank. This transfer circuit comprises a first pipe 4 having two ends that are connected to the upper parts of the first 2 and second 3 tanks, respectively. This first pipe 4 comprising at least one valve 5 (and for example preferably at least two valves in series), one end of which is connected to the second tank 3, comprises detachable connection members so as to allow successive connections to various tanks that are to be supplied with fluid.

The transfer circuit comprises a second pipe 6 that is able to connect the lower part of the first tank 2 to the second tank 3 (in the upper and/or lower part). In the example shown, the second pipe 6 comprises two downstream ends that are connected to the lower and upper parts of the second tank 3, respectively.

The second transfer pipe 6 comprises a pump 7 comprising an inlet connected to the first tank 2 and an outlet connected to the second tank 3. This second pipe 6 preferably comprises a set of one or more valves making it possible to interrupt or authorize the transfer of liquid flow from the first tank 2 to the second tank 3. As above, at least at its one or more downstream ends connected to the second tank 3, the second pipe 6 comprises detachable connection members so as to allow successive connections to various tanks that are to be supplied.

The pump 7 and the set of valves 5 of the first pipe 4 are configured to place the upper parts (gas phases) of the first 2 and second 3 tanks in fluidic communication during and/or before a transfer of liquid from the first tank 2 to the second tank 3 by way of the pump 7.

Placing the gas headspaces of the two tanks 2, 3 in communication during pumping improves the thermal and hydraulic efficiency of the transfer of fluid in an optimized sequential procedure. This makes the use of an atmospheric heater on the first tank 2 optional, and allows the gas headspace of the second tank 3 to be put to profitable use while at the same time improving the quality of the molecule delivered and the volumetric efficiencies of the deliveries.

Thus, while the pump 7 circulates liquid from the first tank 2 to the second tank 3, the second pipe 6 allows the “surplus” gas present in the second tank 3 to circulate by means of a pressure differential towards the first tank 2, in particular so as to fill the volume left free by the withdrawal of liquid.

As illustrated, preferably, at least part of the first pipe 4 is thermally insulated, for example via vacuum insulation. This provides numerous advantages.

The recovered gas is thus kept cold and does not increase the temperature of the liquid hydrogen in the first tank 2. This also limits inputs of heat during deliveries and reduces boil-off losses throughout the supply chain. The pressure remains low in the first tank 2 during the operations because a small amount of heat is introduced therein during delivery.

According to one advantageous particular feature, the first pipe 4 comprises a bypass portion 9 equipped with a heater 13 and a set of one or more valves 10 configured to make it possible to modify the temperature of the flow of gas transferred from the second tank 3 to the first tank 2 via the first pipe 4.

In other words, at least part of the flow of gas passing from the second tank 3 to the first tank 2 via the first pipe 4 can be diverted into the bypass portion 9 to be heated therein by the heater 13 before being sent downstream into the first pipe 4 before supplying the first tank 2. The heater may comprise a heat exchanger, for example supplying heating power.

As illustrated, the bypass portion 9 may comprise two ends respectively connected on either side of the first valve 5. The bypass portion 9 is, for example, a pipe bypassing the first valve.

As illustrated, the bypass portion 9 may comprise a second valve 10, preferably with gradual opening in order to enable flowrate control. This makes it possible to regulate the proportion of the flowrate of gas passing or not passing through the bypass portion 9 in order to be heated.

The installation preferably comprises a temperature sensor 11 measuring the temperature in the first pipe, for example between the bypass portion 9 and the first tank 2, i.e. in the downstream part of the first pipe that receives the mixture of heated gas and unheated gas.

As illustrated, the installation may comprise or be connected to an electronic control unit 12 for acquiring and processing data (comprising, for example, a microprocessor). This control unit 12 can be configured to receive the measurement signal from the temperature sensor 11 and to control the second flowrate control valve 10 on the basis of this signal.

Controlling the temperature of the gas transferred from the second tank 3 to the first tank 2 makes it possible to ensure a relatively stable pressure in the tanks 2, 3 during deliveries.

The temperature of the gas supplied can be monitored by the temperature sensor 11. A predefined optimum temperature for the return gas can be set. This can be obtained via the second valve 10. For example, this temperature can be defined in order to improve the efficiency of the supply chain, on the basis of the type of supply chain.

By virtue of this bypass portion 9, in addition to the possibility of controlling the temperature of the boil-off gas transferred in particular to the first tank 2, the installation 1 can purge all or part of the transfer circuit and in particular the first pipe 4.

For example, before the operation of transferring liquid and gas between the tanks 2, 3, the installation can use the gas allowed to circulate in the bypass portion 9 to purge all or part of the pipes, for example with the hydrogen from the second tank 3, which is heated to a relatively hot temperature (for example of between −50° C. and 30° C.).

The gaseous hydrogen supplied by the second tank 3 can be fully heated for initial purges in order to consume as little gas as possible while at the same time maintaining a high volumetric flowrate for excellent purging efficiency.

Similarly, this gas heated in the bypass portion 9 may be used for an operation of purging all or part of the circuit after a delivery of liquid.

The gas withdrawn from the second tank 3 can be fully heated in order to consume as little gas as possible while at the same time maintaining a high volumetric flowrate for high purging efficiency.

In the case of a delivery of liquefied gas, such as hydrogen for example, the first tank 2 can arrive at the site of the second tank 3. The first tank 2 has, for example, an internal pressure of between 1 and 6 bara. The operator can connect the two tanks 2, 3 using the first 4 and second 6 pipes. During this connection, the sets of valves are closed.

After the operations of inerting and/or purging and/or cooling the pipes 4, 6, pressure equalization is carried out between the two tanks 2, 3 via, in particular, the opening of the first and/or second valve 10.

Preferably, when the difference in pressure between the two tanks 2, 3 is reduced to close to 0 bar (or to a determined value below 1 bar, for example), the pump 7 can then be started.

As illustrated, the second tank 3 may comprise a system 8 for pressurizing the tank 3, comprising, for example, a pipe that connects the lower and upper parts of the tank 3 and is equipped with a heater and a set of one or more valves.

This pressurization of the second tank 3 and/or of the first tank may be carried out simultaneously with a step of transferring liquid from the first tank 2 to the second tank 3 via the pump 7.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A method for transferring cryogenic fluid between a first tank and a second cryogenic tank, the method comprising the steps of:
providing a cryogenic fluid transfer device comprising:
the first tank configured to distribute cryogenic fluid, said first tank storing a cryogenic fluid with a lower liquid phase and an upper gas phase,
the second cryogenic tank housing a cryogenic fluid comprising a lower liquid phase and an upper gas phase,
a fluid transfer circuit connecting the first tank and the second cryogenic tank, the fluid transfer circuit comprising:
a first pipe that connects the upper parts of the first tank and the second cryogenic tank and comprises at least one first valve,
a second transfer pipe that connects the lower part of the first tank to the second cryogenic tank, the second transfer pipe comprising a pump having an inlet connected to the first tank and an outlet connected to the second cryogenic tank, the pump and the first valve being configured to place the upper parts of the first tank and the second cryogenic tank in fluidic communication by opening the first valve,
wherein the first pipe further comprises a bypass portion equipped with a heater and a set of one or more valves configured to modify a temperature of a flow of gas transferred from the second cryogenic tank to the first tank via the first pipe,
transferring liquid from the first tank to the second cryogenic tank via the pump; and,
prior to and/or simultaneously with this liquid transfer step, placing the upper parts of the first and second tanks in fluidic communication by opening the first valve,
circulating, in the first pipe, a flow of gas taken from the second cryogenic tank,
wherein the flow of gas circulated in the first pipe is transferred into the first tank at a determined temperature controlled by regulating the proportion of the flow of gas allowed to pass through the bypass portion.

2. The method according to claim 1, wherein at least part of the flow of gas circulated in the first pipe is preheated in the bypass portion.

3. The method according to claim 1, wherein, during the step of transferring liquid from the first tank to the second cryogenic tank by way of the pump, the liquid is transferred into the lower liquid part and/or into the upper gas part of the second cryogenic tank.

4. The method according to claim 1, wherein the bypass portion comprises two ends respectively connected on either side of the first valve.

5. The method according to claim 1, wherein the bypass portion comprises a second flowrate control valve.

6. The method according to claim 1, wherein the device further comprises a temperature sensor measuring the temperature in the first pipe between the bypass portion and the first tank.

7. The method according to claim 6, further comprising an electronic control unit for acquiring and processing data, the control unit being configured to receive a measurement signal from the temperature sensor and to control the second flowrate control valve on the basis of this measurement.

8. The method according to claim 1, wherein the second pipe comprises an end connecting the lower part of the first tank to the lower part of the second cryogenic tank.

9. The method according to claim 1, wherein the second pipe comprises an end connecting the lower part of the first tank to the upper part of the second cryogenic tank.

10. The method according to claim 1, wherein at least part of the first pipe is thermally insulated, for example via vacuum insulation.

11. The method according to claim 1, further comprising a purging step before transferring liquid, wherein gas from the second cryogenic tank is heated in the bypass portion and used to purge the fluid transfer circuit.

12. The method according to claim 1, further comprising a step of equalizing pressure between the first tank and the second cryogenic tank by opening the first valve before starting the pump.

13. The method according to claim 1, wherein the cryogenic fluid is liquefied hydrogen.

14. The method according to claim 1, wherein the determined temperature of the gas transferred into the first tank is controlled to be between −50° C. and 30° C.

15. A device for transferring cryogenic fluid, comprising:
a first tank configured to distribute cryogenic fluid, said first tank storing a cryogenic fluid with a lower liquid phase and an upper gas phase;
a second cryogenic tank for housing a cryogenic fluid comprising a lower liquid phase and an upper gas phase; and
a fluid transfer circuit connecting the first tank and the second cryogenic tank, the fluid transfer circuit comprising:
a first pipe that connects the upper parts of the first tank and the second cryogenic tank and comprises at least one first valve;
a second pipe that connects the lower part of the first tank to the second cryogenic tank, the second pipe comprising a pump having an inlet connected to the first tank and an outlet connected to the second cryogenic tank;
wherein the first pipe comprises a bypass portion equipped with a heater and a set of one or more valves configured to modify a temperature of a flow of gas transferred from the second cryogenic tank to the first tank via the first pipe.

16. The device according to claim 15, wherein the bypass portion comprises two ends respectively connected on either side of the first valve.

17. The device according to claim 15, wherein the bypass portion comprises a second flowrate control valve.

18. The device according to claim 15, further comprising a temperature sensor configured to measure the temperature in the first pipe between the bypass portion and the first tank.

19. The device according to claim 18, further comprising an electronic control unit configured to receive a measurement signal from the temperature sensor and to control the second flowrate control valve based on the measurement signal.

20. The device according to claim 15, wherein at least part of the first pipe is vacuum insulated.
